(19) United States
(12) Patent Application Publication
(10) Pub. No.: US 2019/0178661 A1
(43) Pub. Date: Jun. 13, 2019

(54) NAVIGATION APPARATUS, NAVIGATION SYSTEM AND IMAGE DISPLAY METHOD

(71) Applicants: DENSO TEN Limited, Kobe-shi (JP); TOYOTA JIDOSHA KABUSHIKI KAISHA, Toyota-shi (JP)

(72) Inventors: Yusuke SAKAIDA, Kobe-shi (JP); Youichi SUZUKI, Toyota-shi (JP)

(73) Assignees: DENSO TEN Limited, Kobe-shi (JP); TOYOTA JIDOSHA KABUSHIKI KAISHA, Toyota-shi (JP)

(21) Appl. No.: 16/199,539

(22) Filed: Nov. 26, 2018

(30) Foreign Application Priority Data
Dec. 12, 2017 (JP) 2017-237851

(51) Int. Cl. G01C 21/34; G01C 21/36; G01C 21/20

(52) U.S. Cl. CPC G01C 21/3469; G01C 21/20; G01C 21/3679; G01C 21/3697

(57) ABSTRACT

A navigation apparatus to be mounted in a vehicle includes a necessary remaining amount calculation unit, a reaching probability determination unit, and a display mode control unit, and for each of predetermined sections, the reaching probability determination unit determines a reaching probability of reaching an end point of the section, and the display mode control unit successively changes display modes of the sections displayed on a display screen according to the reaching probabilities for the respective sections determined by the reaching probability determination unit.

### CROSS-REFERENCE TO RELATED APPLICATION

This application is based upon and claims the benefit of prior Japanese Patent Application No. 2017-237851 filed on Dec. 12, 2017, the entire contents of which are incorporated herein by reference.

### FIELD

The present invention relates to a navigation apparatus, a navigation system and an image display method.

### BACKGROUND

Conventionally, navigation apparatuses in which a function that detects a remaining amount of fuel and a car navigation function cooperate with each other to predict a timing for fueling a vehicle and guide a driver to a fueling site have been proposed. Such navigation apparatuses each calculate a distance that the vehicle can run based on a remaining fuel amount and an average fuel efficiency and indicate and guide the driver to a gas station located at a distance from a current position, the distance being shorter than the calculated distance.

In relation to the above, Patent document 1 proposes a navigation apparatus that after leaning fueling timings and fueling sites from behaviors of a driver of a vehicle, predicts a fuel consumption amount from a destination and a running route and suggests fueling at a fueling site fitting the driver's preferences. Also, Patent document 2 proposes a navigation apparatus that if a remaining fuel amount in a relevant vehicle becomes a predetermined value or less, displays, on a map, a round range in which the vehicle can run, with a current position as a center and a range of distance according to a value of a remaining fuel amount at that point of time as a radius based on the remaining fuel amount at that point of time. Also, Patent document 3 proposes a navigation apparatus that displays a travelable range on a map, using a travelable range calculation unit that calculates a range in which a relevant vehicle can travel with a current remaining energy amount using a drive energy consumption rate corresponding to an energy consumption amount per unit time, the energy consumption amount being necessary for driving devices mounted in the relevant vehicle.

[Patent document 1] Japanese Paten Laid-Open No. 2014-157021

[Patent document 2] Japanese Paten Laid-Open No. 2006-275774

[Patent document 3] Japanese Paten Laid-Open No. 2014-130152

### SUMMARY

With the above-stated techniques, a user can recognize a range that a relevant vehicle is highly likely to reach with a current remaining fuel amount. However, an actual fuel efficiency, thus, a distance that the vehicle can actually run varies successively depending on road conditions (for example, traffic congestion, etc.) and/or a state of the vehicle (e.g., an operating status of an air conditioner, etc.). Therefore, there is a risk of gasoline being completely consumed before reaching a point initially regarded as reachable and resulting in a failure to reach a destination.

The present invention has been made in order to solve such problem above, and an object of the present invention is to provide a technique that can correctly display to a user a range that a vehicle can reach with a current remaining fuel amount and without refueling in a navigation apparatus mounted in the vehicle.

In order to solve the aforementioned problem, the present invention employs the following means. In other words, the present invention provides

a navigation apparatus to be mounted in a vehicle, the apparatus including:

a necessary remaining amount calculation unit that for each of predetermined sections into which a guide route from a current position of the vehicle to a destination is divided, calculates a necessary remaining amount that is a remaining amount of fuel, the remaining amount being necessary for reaching an end point of the section from the current position of the vehicle;

a reaching probability determination unit that based on a current remaining amount of the fuel and the necessary remaining amount, determines a reaching probability that is a probability of whether or not the vehicle can reach a particular position from the current position without refueling; and

a display mode control unit that changes a display mode of a display object displayed in a display image, wherein:

for each of the sections, the reaching probability determination unit determines the reaching probability of reaching an end point of the section; and

the display mode control unit successively changes display modes of the sections displayed in a display image according to the reaching probabilities for the respective sections determined by the reaching probability determination unit.

According to the present invention, a guide route can be displayed in a graded fashion according to reaching probabilities. Consequently, a user can intuitively recognize a range that a relevant vehicle can reach with a current remaining fuel amount and without refueling. Furthermore, the display mode control unit successively changes display modes according to the reaching probabilities, enabling the range that the vehicle can reach with a current remaining fuel amount and without refueling to be correctly displayed to the user.

Also, the present invention can be specified as a navigation system. In other words, the present invention may provide

a navigation system to be mounted in a vehicle, the system including:

a necessary remaining amount calculation unit that for each of predetermined sections into which a guide route from a current position of the vehicle to a destination is divided, calculates a necessary remaining amount that is a remaining amount of fuel, the remaining amount being necessary for reaching an end point of the section from the current position of the vehicle;

a reaching probability determination unit that based on a current remaining amount of the fuel and the necessary remaining amount, determines a reaching probability that is a probability of whether or not the vehicle can reach a particular position from the current position without refueling; and

a display mode control unit that changes a display mode of a display object displayed in a display image, wherein:

for each of the sections, the reaching probability determination unit determines the reaching probability of reaching an end point of the section; and

the display mode control unit successively changes display modes of the sections displayed in a display image according to the reaching probabilities for the respective sections.

Also, the present invention can be specified as an image display method for vehicle navigation. In other words, the present invention may provide

an image display method for a vehicle navigation system, the method including:

for each of predetermined sections into which a guide route from a current position of the vehicle to a destination is divided, calculating a necessary remaining amount that is a remaining amount of fuel, the remaining amount being necessary for reaching an end point of the section from the current position of the vehicle;

based on a current remaining amount of the fuel and the necessary remaining amount, determining a reaching probability that is a probability of whether or not the vehicle can reach a particular position from the current position without refueling; and

changing a display mode of a display object displayed in a display image, wherein:

for each of the sections, the determining determines the reaching probability of reaching an end point of the section; and

the changing successively changes display modes of the sections displayed in a display image according to the reaching probabilities for the respective sections.

The present invention enables correctly displaying a range that a relevant vehicle can reach with a current remaining fuel amount to a user in a navigation apparatus.

### BRIEF DESCRIPTION OF THE DRAWINGS

FIG. 1 is a diagram illustrating an overall configuration of a navigation system according to an embodiment.

FIG. 2 is a diagram illustrating a functional configuration of the navigation apparatus according to the embodiment.

FIG. 3 is a diagram illustrating an example of a hardware configuration of the navigation apparatus according to the embodiment.

FIG. 4 is a flowchart of display control processing according to the embodiment.

FIG. 5A is a diagram illustrating a relationship between power consumption and fuel efficiency influence value of an air conditioner as an example of a fuel efficiency influencing device.

FIG. 5B is a diagram illustrating past average fuel efficiencies stored in a storage unit.

FIG. 6 is a detailed flowchart of reaching probability determination processing performed by a necessary remaining amount calculation unit.

FIG. 7 is a diagram illustrating a route guide image displayed on a display apparatus and is a diagram illustrating a specific example for describing processing performed in the embodiment.

FIG. 8 is a detailed flowchart of processing performed by a priority provision unit.

FIG. 9 is a diagram for describing a specific example of processing performed in the embodiment.

FIG. 10 is a diagram illustrating gas station use history data in the specific example.

FIG. 11 is a diagram illustrating convenience store use history data in the specific example.

FIG. 12 is a diagram illustrating a route guide image displayed on the display apparatus and is a diagram indicating a result of the processing in the specific example illustrated in FIG. 9.

### DESCRIPTION OF EMBODIMENTS

A preferred embodiment of the present invention will be described below with reference to the drawings. However, the embodiment described below is a mere example for carrying out the present invention, and the present invention is not limited to the mode described below.

### Embodiment

### [System Configuration]

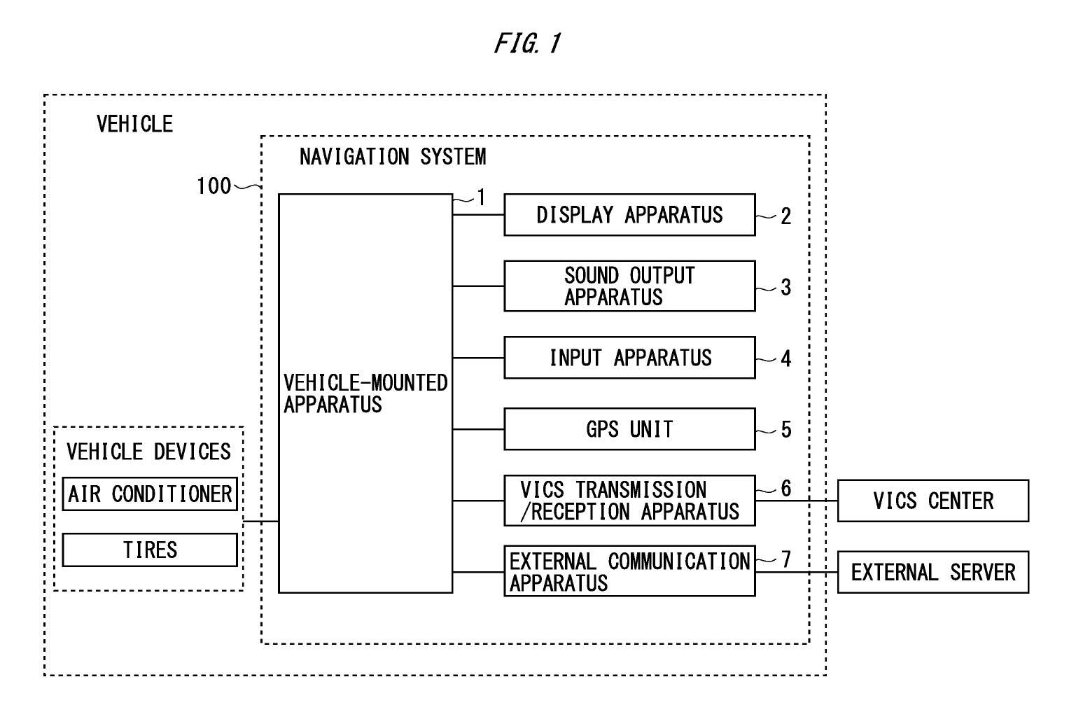

FIG. 1 is a diagram illustrating an overall configuration of a navigation system 100 according to the present embodiment. The navigation system 100 according to the present embodiment is used in a vehicle that runs with running energy from a fuel such as gasoline. The navigation system 100 according to the present embodiment can display a probability of whether or not the vehicle can reach a particular position on a route without refueling to a user (mainly a driver) by performing later-described special display control processing. Although in the present embodiment, a gasoline is indicated as an example of the fuel, the fuel is not limited to this example and any of light oil, natural gas and other fuels may be used. The navigation system 100 according to the present embodiment successively changes route display according to reaching probabilities calculated based on a remaining fuel amount and a fuel efficiency. A configuration of the system 100 according to the present embodiment will be described below.

As illustrated in FIG. 1, the navigation system 100 includes a vehicle-mounted apparatus 1, which serves as a navigation apparatus, a display apparatus 2 that provides various types of image display such as a map display screen, a sound output apparatus 3 that outputs various types of sound information such as a voice guide, an input apparatus 4 for inputting various types of instructions from the user, a GPS unit 5 that detects a current position of the vehicle, and a VICS transmission/reception apparatus 6 and an external communication apparatus 7 that acquire information via a network.

The display apparatus 2 is disposed at a position in a cabin of the vehicle at which the user can view the display apparatus 2, and displays to the user various types of visual information, such as a map display screen, supplied from the vehicle-mounted apparatus 1. The display apparatus 2 is, for example, a liquid-crystal display. The display apparatus 2 may be integrated with the vehicle-mounted apparatus 1.

The sound output apparatus 3 includes a sound output device such as a speaker and outputs various types of sound information such as guide voices and warning sounds to the user.

The input apparatus 4 is disposed at a position at which the user can operate the input apparatus 4, receives an input operation provided by the user and outputs a signal according to the input operation to the vehicle-mounted apparatus 1. The input apparatus 4 includes, e.g., a touch screen disposed so as to be superimposed on the display apparatus 2 and physical buttons. The user operates the vehicle-mounted apparatus 1 by touching the touch screen or pressing the buttons. Also, the input apparatus 4 may receive the driver's voice via a sound input device such as a microphone and output a signal according to the voice to the vehicle-mounted apparatus 1.

The GPS unit 5 is means for acquiring information of a current position of the vehicle. The GPS unit 5 receives GPS information from a GPS artificial satellite via a GPS antenna and calculates coordinates of a position of the GPS unit 5 (thus, the relevant vehicle) based on the received signal.

The VICS transmission/reception apparatus 6 acquires road traffic information transmitted by VICS (Vehicle Information and Communication System (registered trademark)) Center and outputs the road traffic information to the vehicle-mounted apparatus 1. Examples of the road traffic information include, e.g., whether or not a traffic congestion has occurred and whether or not road traffic regulations have been imposed. The external communication apparatus 7 acquires environmental information by performing communication with an external server. Although details will be described later, examples of the environmental information include, e.g., weather, temperature, wind direction and wind speed.

[Apparatus Configuration]

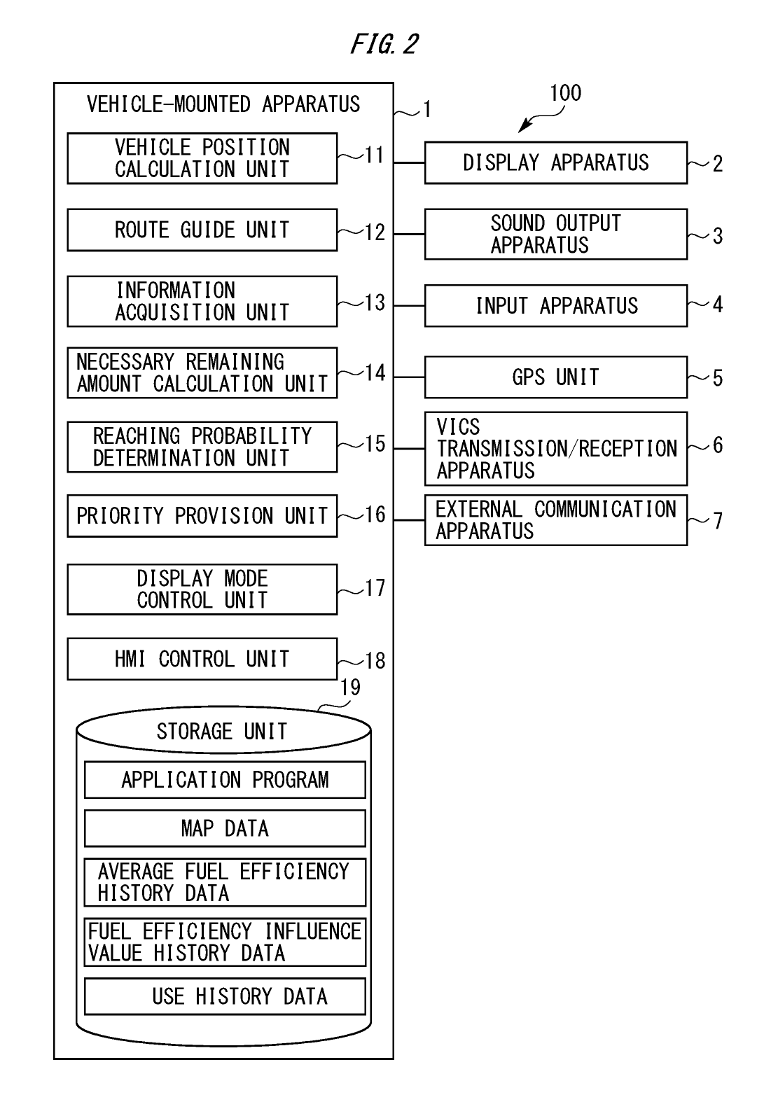

FIG. 2 is a diagram illustrating a functional configuration of the vehicle-mounted apparatus 1. The vehicle-mounted apparatus 1 is what is called a car navigation apparatus. The vehicle-mounted apparatus 1 includes a vehicle position calculation unit 11, a route guide unit 12, an information acquisition unit 13, a necessary remaining amount calculation unit 14, a reaching probability determination unit 15, a priority provision unit 16, a display mode control unit 17, an HMI (human machine interface) control unit 18 and a storage unit 19.

In the storage unit 19, an application program for causing the vehicle-mounted apparatus 1 to operate, map data, average fuel efficiency history data, fuel efficiency influence value history data, the number of times of use of gas stations by the user by brand and use history data indicating the number of times of use of convenience stores by chain are stored. Also, the storage unit 19 stores results of processing performed by the vehicle-mounted apparatus 1.

The map data mainly include road data to be used for representing road shapes and POI (point of interest) data representing names, positions, types, phone numbers, etc., of various facilities. The map data are compartmented into predetermined ranges called “meshes” and are filed separately in units of meshes.

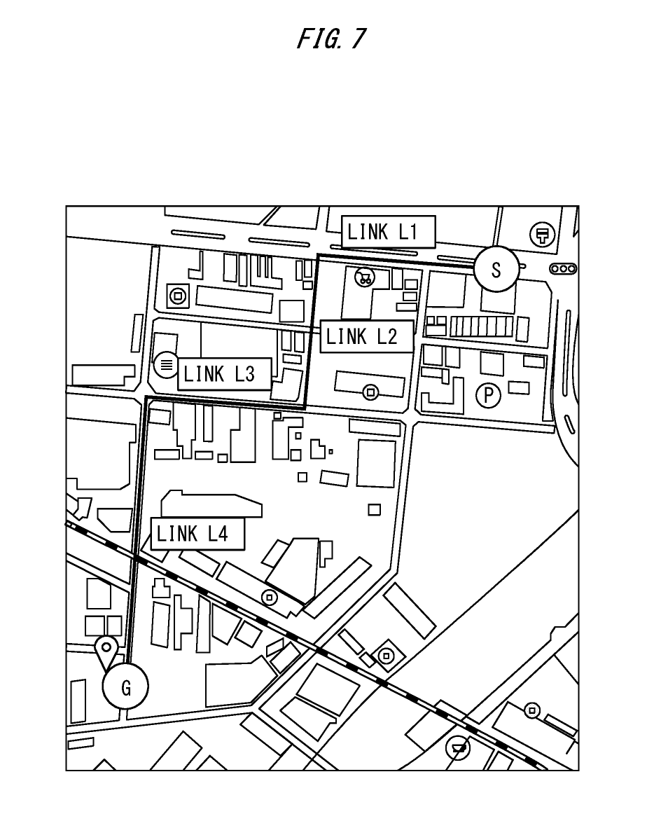

The road data are divided into predetermined road sections. A minimum unit indicating each divisional road section is called “link”. In other words, each of the road data is formed by a series of a plurality of links set in each predetermined road section (see FIG. 7). However, the road sections set by the links differ in length and thus the lengths of the links are not uniform. Also, points interconnecting links is called “node (s)”. Each node has position information (coordinate information) and shapes of the links and shapes of roads are determined by the position information that the nodes have.

The HMI control unit 18 controls an interface for performing an input and an output of information between the user and the vehicle-mounted apparatus 1. In other words, the HMI control unit 18 controls the display apparatus 2, the sound output apparatus 3 and the input apparatus 4 described above. Also, the HMI control unit 18 generates an image to be displayed on the display apparatus 2 based on instructions from the route guide unit 12 and the display mode control unit 17 and causes the generated image to be displayed on the display apparatus 2.

The vehicle position calculation unit 11 calculates a current position of the relevant vehicle on a map by matching information of the current position of the relevant vehicle, which has been acquired from the GPS unit 5, and map data acquired from the map data with each other.

The route guide unit 12 provides a general car navigation function. Upon receipt of a setting of a destination by the user via the input apparatus 4, the route guide unit 12 creates a route from the current position to the destination. The car navigation function of the route guide unit 12 will be described below.

First, upon the user inputting, e.g., an address or a name of a facility designated as a destination by operating the input apparatus 4 via a screen displayed on the display apparatus 2, the route guide unit 12 searches for destination candidates from the map data. Next, the route guide unit 12 sets one selected by the user, from among the destination candidates displayed on the display apparatus 2, via the HMI control unit 18, as a destination. Next, the route guide unit 12 creates a plurality of running routes to the destination based on information on a position of the destination, information on a current position of the relevant vehicle and the road data stored in the storage unit 19. Examples of the running routes include, e.g., a route for earliest reaching of the destination, the route including an expressway (shorter distance-preferred route), a route for most inexpensive reaching of the destination, the route including no toll road (local road-preferred route). The HMI control unit 18 displays the created routes on the display apparatus 2 as route candidates. Then, the route guide unit 12 sets one selected by the user, from among the route candidates, as a guide route. Based on an instruction from the route guide unit 12, the HMI control unit 18 causes a route guide image in which an icon indicating a POI of the current position of the relevant vehicle and the set guide route are superimposed on a map to be displayed on the display apparatus 2, thereby informing the user of the current position of the relevant vehicle and the guide route. Also, upon the current position of the vehicle deviating from the guide route, the route guide unit 12 creates a guide route from the current position to the destination. Consequently, during the route guiding, the guide route is updated (rerouted) so that the route from the current position of the relevant vehicle to the destination is consistently indicated to the user. The car navigation function is provided in such a manner as described above. However, means for providing the car navigation function is not limited to the above and any existing means may be used.

The information acquisition unit 13 acquires information necessary for determining a probability of reaching a destination or a refueling point (gas station in the present example). The necessary remaining amount calculation unit 14 calculates a remaining fuel amount necessary for reaching a particular position from a current position. The reaching probability determination unit 15 determines a probability of whether or not the vehicle can reach the particular position from the current position without refueling. The priority provision unit 16 provides later-described priorities for refueling points. The display mode control unit 17 changes display modes of a guide route and icons of the refueling points displayed on a display image, based on results of determination by the reaching probability determination unit 15 and the priority provision unit 16. Detailed functions of the information acquisition unit 13, the necessary remaining amount calculation unit 14, the reaching probability determination unit 15, the priority provision unit 16 and the display mode control unit 17 will be described later.

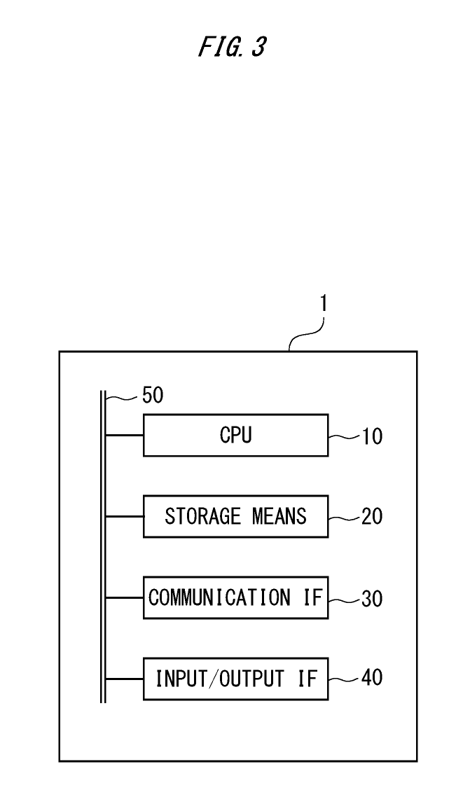

FIG. 3 is a diagram illustrating an example of a hardware configuration of the vehicle-mounted apparatus 1. As illustrated in FIG. 3, the vehicle-mounted apparatus 1 includes a CPU (central processing unit) 10, a memory 20, a communication IF 30 and an input/output IF 40 mutually connected via a connection bus. The CPU 10 is a central processing unit that performs overall control of the vehicle-mounted apparatus 1. The CPU 10 is also called “processor”. However, the CPU 10 is not limited to a single processor and may have a multiprocessor configuration. Also, it is possible that a single CPU 10 connected via a single socket has a multicore configuration. In the vehicle-mounted apparatus 1, the CPU 10 executes a navigation program and thereby functions as respective processing units of the vehicle position calculation unit 11, the route guide unit 12, the information acquisition unit 13, the necessary remaining amount calculation unit 14, the reaching probability determination unit 15, the priority provision unit 16, the display mode control unit 17 and the HMI control unit 18 illustrated in FIG. 2. However, processing in the respective processing units may be at least partially provided by, e.g., a DSP (digital signal processor) or an ASIC (application specific integrated circuit). Also, at least a part of the respective processing units may be a dedicated LSI (large-scale integration) such as an FPGA (field-programmable gate array) or another digital circuit. Also, a configuration in which at least part of the respective processing units includes an analog circuit may be employed.

The memory 20 includes a ma in memory and an auxiliary memory. The main memory is a storage medium that functions as the storage unit 19 illustrated in FIG. 2 and allows the CPU 10 to cache a program and data therein or develop a work area. The main memory includes, for example, a flash memory, a RAM (random access memory) or a ROM (read-only memory). The auxiliary memory is a recording medium in which a database, which is illustrated in FIG. 2 is mainly recorded. The auxiliary memory includes, for example, an HDD (hard-disk drive), an SSD (solid state drive), an EPROM (erasable programmable ROM), a flash memory, a USB memory or a memory card.

The communication IF 30 is an interface that can be connected to a general-purpose network via a base station through a wireless telephone line. Also, the communication IF 30 is communicable with an access point (AP) of wireless LAN and is connectable to the network via arbitrary communication means.

The input/output IF 40 is an interface via which data is input/output from/to the devices connected to the vehicle-mounted apparatus 1 such as the display apparatus 2, the input apparatus 4 and an ECU. The input/output IF 40 functions as the HMI control unit 18 illustrated in FIG. 2. An input by the user via the input apparatus 4 is provided to the vehicle-mounted apparatus 1 via the input/output IF 40.

[Route Guide Image Display Method]

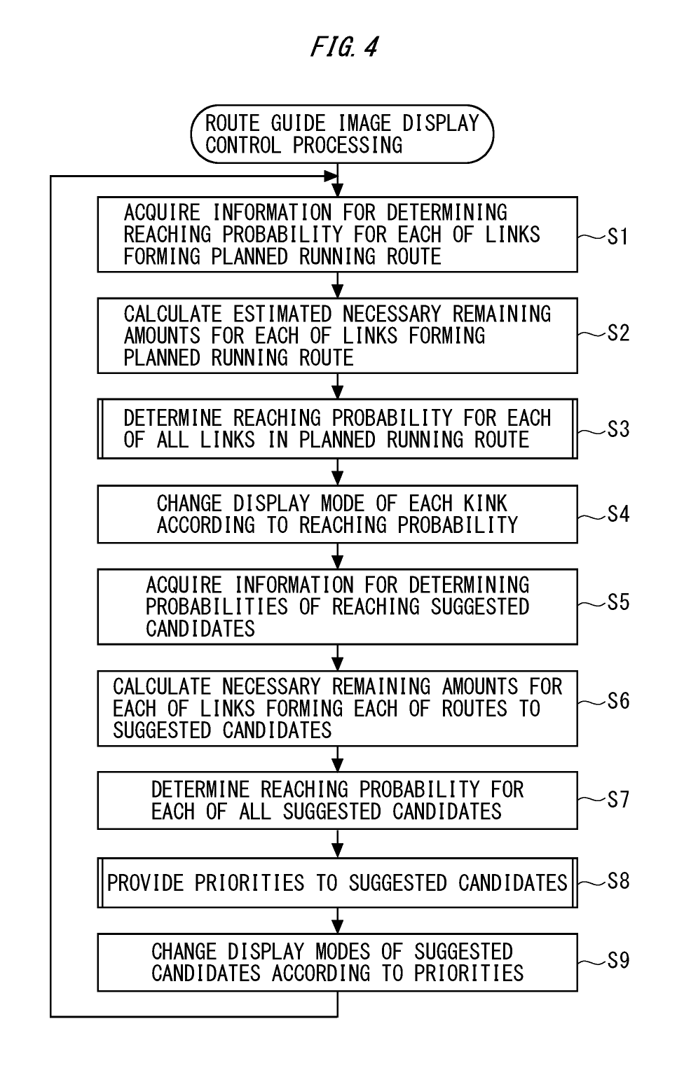

Next, a route guide image display method in vehicle navigation performed by the vehicle-mounted apparatus 1 according to the present embodiment will be described. FIG. 4 is a flowchart for route guide image display control processing performed by the vehicle-mounted apparatus 1 in the image display method according to the present embodiment.

The present processing is successively performed during performance of the navigation function by the route guide unit 12. First, the information acquisition unit 13 acquires various kinds of information for determining a reaching probability for each of links forming a route that the relevant vehicle runs from that point of time (hereinafter, “planned running route”), that is, a route from a current position of the relevant vehicle to a destination, in a guide route (step S1). More specifically, the information acquisition unit 13 acquires a remaining fuel amount, an instantaneous fuel efficiency, an average fuel efficiency and fuel efficiency influencing factor information.

A remaining fuel amount refers to a current amount of fuel stored in a fuel tank of the vehicle. The information acquisition unit 13 acquires a remaining fuel amount at the current point of time from a remaining fuel amount sensor. Also, fuel efficiency refers to a distance that the vehicle can run with a unit amount of fuel. Therefore, as a value of the fuel efficiency is higher, the fuel efficiency is better and as the value of the fuel efficiency is lower, the fuel efficiency is worse. The fuel efficiency can be regarded as the number of kilometers the vehicle can run with a liter of fuel, and in such case, can be expressed by “km/l”. An instantaneous fuel efficiency is, for example, a result of a running distance per second being divided by a fuel injection amount (fuel consumption amount) per second. An average fuel efficiency is, for example, an average value of instantaneous fuel efficiencies from an engine start of this time to the present. Also, an average fuel efficiency may be a result of a running distance from the engine start of this time to the present being divided by the fuel consumption amount. The instantaneous fuel efficiency and the average fuel efficiency can be acquired by a known technique.

Fuel efficiency influencing factor information refers to information on statuses of fuel efficiency influencing factors. In the present description, a fuel efficiency influencing factor refers to an element which has an influence on an actual fuel efficiency of the vehicle (hereinafter “actual fuel efficiency”) that varies depending on a status thereof. The fuel efficiency influencing factor information is further divided into vehicle information, which is information on vehicle device factors, environmental information, which is information on environmental factors, and road information, which is information on road factors. A vehicle device factor refers to a vehicle device which has an influence on fuel efficiency that varies depending on a status thereof. Examples of the vehicle device factors include, e.g., electronic devices which have an influence on fuel efficiency that varies depending on power consumption increase/decrease, such as an air conditioner, room lights, a heater, wipers and headlights and tires which have an influence on fuel efficiency that varies depending on air pressure. An environmental factor refers to a factor in an external environment of the vehicle which has an influence on fuel efficiency that varies depending on change in environment. Examples of the environmental factors include, e.g., weather (sunny/cloudy/raining/snowing), air temperature, wind direction and wind speed. A road factor refers to a state of a road in the planned running route which has an influence on fuel efficiency that varies depending on change in state thereof. Examples of the road factors include, e.g., a road congestion status, a road surface condition (dry/wet/snow-covered/frozen) and road surface inclination.

The information acquisition unit 13 acquires information of power consumption of the air conditioner, air pressure of the tires, etc., as vehicle information from devices of the respective units of the vehicle. Also, the information acquisition unit 13 acquires information of weather, a congestion status, an air temperature, a wind direction, a wind speed, etc., as environmental information from the network via the VICS transmission/reception apparatus 6 and the external communication apparatus 7. Also, the information acquisition unit 13 acquires information of a road surface condition and road inclination as road information from the map data.

Next, in step S2, the necessary remaining amount calculation unit 14 calculates estimated necessary remaining amounts for each of links forming the planned running route (step S2). In the present description, an estimated necessary remaining amount refers to an estimated value of a remaining fuel amount necessary for reaching a particular position from a current position. Also, where an estimated necessary remaining amount is used for a link, the estimated necessary remaining amount refers to an estimated value of a remaining fuel amount necessary for reaching an endpoint of the link (point of a longest running distance from a current position). Although details will be described later, an estimated necessary remaining amount is obtained by dividing a total length of a link by an estimated actual fuel efficiency.

Here, an actual fuel efficiency of a vehicle increases/decreases depending on statuses of the fuel efficiency influencing factors described above. A value of actual fuel efficiency decrease by a fuel efficiency influencing factor in a certain condition is referred to as “fuel efficiency influence value”. In other words, where a fuel efficiency influence value is a positive value, an actual fuel efficiency decreases relative to an average fuel efficiency. Contrarily, where a fuel efficiency influence value is a negative value, an actual fuel efficiency increases relative to an average fuel efficiency.

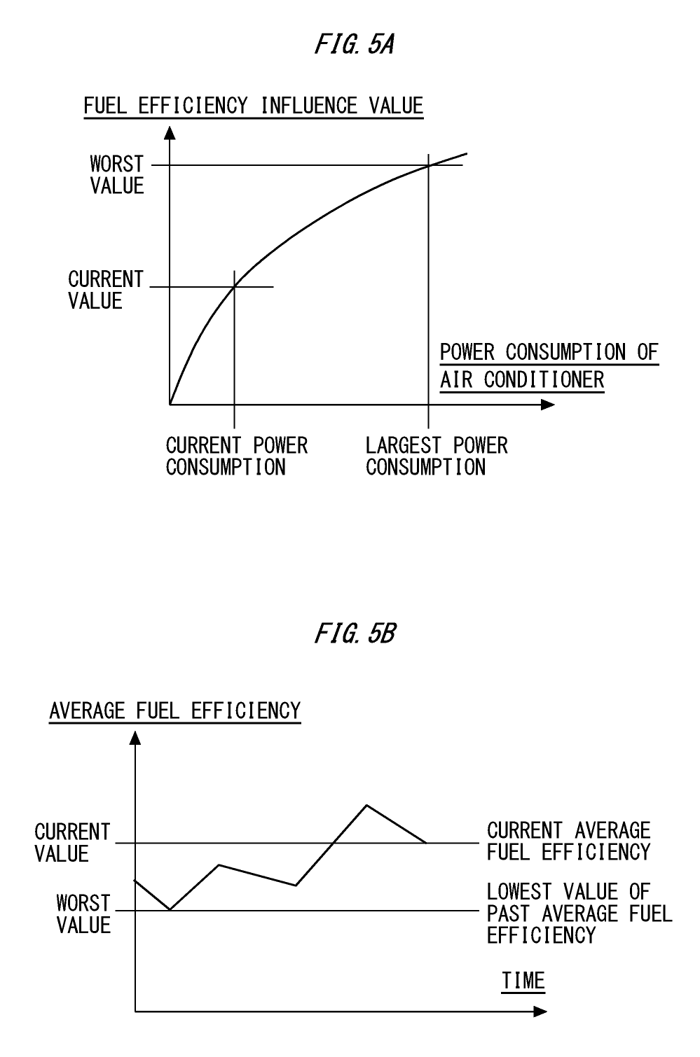

FIG. 5A is a diagram indicating a relationship between power consumption of the air conditioner, which is an example of a fuel efficiency influencing device, and a fuel efficiency influence value. Power consumption of the air conditioner varies depending on operating conditions of the air conditioner, for example, a set temperature and a set air volume. In a state in which the air conditioner does not operate at all, the power consumption is substantially zero and thus the fuel efficiency influence value is substantially zero. Then, upon the power consumption of the air conditioner increasing, the fuel efficiency influence value increases. In other words, along with an increase of the power consumption of the air conditioner, the actual fuel efficiency decreases.

Hereinafter, E denotes a fuel efficiency and e denotes a fuel efficiency influence value. Also, a current average fuel efficiency E0c denotes an average fuel efficiency E at a current point of time. Also, N (N is a positive integer) is a total number of fuel efficiency influencing factors, different numbers of 1 to N are provided to the respective factors, and en is a fuel efficiency influence value of a n-th (n is a positive integer) factor. In particular, a current fuel efficiency influence value enc is a fuel efficiency influence value en at a current point of time. Here, the storage unit 19 holds history data of average fuel efficiencies in past driving. FIG. 5B is a diagram illustrating an example of past average fuel efficiencies stored in the storage unit 19. A worst average fuel efficiency E0b is a lowest average fuel efficiency from among the past average fuel efficiencies stored in the storage unit 19. Also, the storage unit 19 holds history data of fuel efficiency influence values e of the respective fuel efficiency influencing factors in the past driving. A worst fuel efficiency influence value enb is a largest influence value en from among fuel efficiency influence values en in the past.

Here, where an estimated current actual fuel efficiency Eac is an actual fuel efficiency estimated from the current average fuel efficiency E0c and the current fuel efficiency influence values enc of the respective fuel efficiency influencing factors, the estimated current actual fuel efficiency Eac can be expressed by the following formula:

Eac=E0c−e1c−e2c− . . . enc . . . eNc Formula (1).

In other words, an estimated current actual fuel efficiency refers to an actual fuel efficiency estimated at the current point of time.

Also, where an estimated worst actual fuel efficiency Eab is an actual fuel efficiency estimated from the worst average fuel efficiency E0b and the worst fuel efficiency influence values enb of the respective fuel efficiency influencing factors, the estimated worst actual fuel efficiency Eab is expressed by the following formula:

Eab=E0b−e1b−e2b− . . . enb . . . eNb Formula (2)

In other words, an estimated worst actual fuel efficiency refers to a lowest value of an actual fuel efficiency estimated.

Hereinafter, M (M is a positive integer) denotes a number of the links forming the planned running route. Also, a link L1 is a link closest to a current position of the vehicle, that is, a link in which the relevant vehicle is currently located, and a link L2, a link L3, . . . a link LM come after the link 1 in descending order of closeness to the current position. Therefore, the link LM is a link closest to the destination. In the following, D1, D2, . . . DM are lengths of the respective links. A link Ln is a link that is n-th (n is a positive integer) in descending order of closeness to the current position and Dn is a length of the link Ln. In the example illustrated in FIG. 7, M=4, the link L1 is a link closest to the current position and a link L4 is a link closest to the destination.

Referring back to FIG. 4, the estimated necessary remaining amounts calculated by the necessary remaining amount calculation unit 14 in step S2 include estimated current necessary remaining amounts Ya and estimated worst necessary remaining amounts Yb. An estimated current necessary remaining amount Ya refers to an estimated necessary remaining amount estimated where the vehicle runs the route with the estimated current actual fuel efficiency Eac, which is an actual fuel efficiency estimated at the current point of time. An estimated worst necessary remaining amount Yb refers to an estimated necessary remaining amount estimated where the vehicle runs the route with the estimated worst actual fuel efficiency Eab, which is a worst value of an estimated actual fuel efficiency.

Here, an estimated current necessary remaining amount Ync and an estimated worst necessary remaining amount Ynb when the vehicle runs a link Ln are expressed by the following formulas, respectively:

Ync=Dn/Eac Formula (3); and

Ynb=Dn/Eab Formula (4).

In step S2, the necessary remaining amount calculation unit 14 calculates an estimated current necessary remaining amount Ync and an estimated worst necessary remaining amount Ynb based on Formulas (1) to (4) for each of all the links in the planned running route. Here, the necessary remaining amount calculation unit 14 acquires fuel efficiency influence values e of the respective factors based on the influencing factor information acquired by the information acquisition unit 13 in step S1 and introduces the acquired fuel efficiency influence values e to Formula (1) to calculate the estimated current actual fuel efficiency Eac. The fuel efficiency influence values e of the respective factors may be calculated based on the influencing factor information by means of a known method or may be obtained with reference to the influencing factor information and the history data of the fuel efficiency influence values e in the past. Upon an end of step S2, the processing proceeds to step S3.

Next, in step S3, the reaching probability determination unit 15 determines a reaching probability for each of the links in the planned running route (step S3). A reaching probability is an index representing a probability of whether or not a vehicle can reach a particular position from a current position without refueling. Where a reaching probability is used for a link, the reaching probability refers to a probability of whether or not a vehicle can reach an endpoint of the link (point at a longest running distance from the current position). In step S3, as a reaching probability, any of level 1, level 2 and level 3 is provided to each link. Level 1 is provided to a link in which the vehicle is expected to even if the actual fuel efficiency becomes the estimated worst actual fuel efficiency Eab, be able to continue travelling to an endpoint of the link from a current position without refueling. Level 2 is provided to a link in which the vehicle is expected to if the actual fuel efficiency becomes the estimated worst actual fuel efficiency Eab, be unable to continue travelling to an end point of the link from a current position without refueling but if the actual fuel efficiency remains the estimated current actual fuel efficiency Eac, be able to continue travelling to the endpoint of the link without refueling. Level 3 is provided to a link in which the vehicle is expected to even if the actual fuel efficiency remains the estimated current actual fuel efficiency Eac, be unable to continue travelling the link. Based on the above, in the present embodiment, at level 1, the reaching probability can be regarded as highest, and at level 3, the reaching probability can be regarded as lowest.

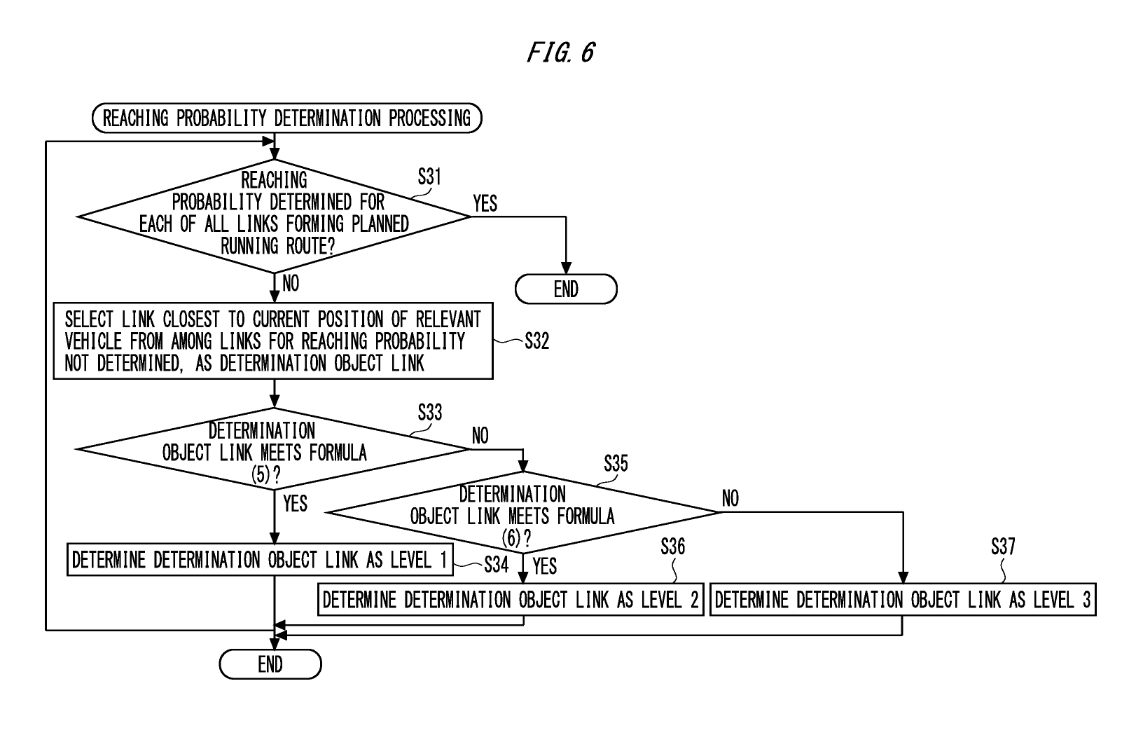

FIG. 6 is a detailed flowchart of reaching probability determination processing performed by the necessary remaining amount calculation unit 14 in step S3. First, in step S31, the necessary remaining amount calculation unit 14 determines whether or not the reaching probability has been determined for each of all the links in the planned running route (step S31). If the reaching probability has been determined for each of all the links in the planned running route (step S31: YES), step S3 is completed. If there are links for which the reaching probability has not been determined from among all the links in the planned running route (step S31: NO), the necessary remaining amount calculation unit 14 selects a link closest to the current position of the relevant vehicle from among the links for which the reaching probability has not been determined, as a determination object link (step S32). Here, m is a number of the determination object link and a link Lm is the determination object link.

Next, in step S33, the reaching probability determination unit 15 determines whether or not conditional formula (5) below is met, for the determination object link Lm (step S33).

$$Y 0 - {\sum }_{n}^{m - 1} Ynb > 0 \qquad formula ( 5 )$$

Here, Y0 is a current remaining fuel amount (hereinafter “current remaining amount”). Formula (5) means that a value of subtraction of a total sum of estimated worst necessary remaining amounts Ynb from the current position to the determination object link Lm from the current remaining amount Y0 is larger than zero. If formula (5) is met, the vehicle is expected to even if the vehicle runs with the estimated worst actual fuel efficiency Eab, be able to continue traveling to an end point of the determination object link Lm without refueling. In other words, the determination object link Lm can be regarded as a link in which even if the actual fuel efficiency varies from the estimated current actual fuel efficiency Eac, which is an actual fuel efficiency estimated at the current point of time, to the estimated worst actual fuel efficiency Eab, which is a worst value of an estimated actual fuel efficiency, the vehicle can continue travelling to the endpoint of the link without refueling. Therefore, if formula (5) is met (step S33: YES), the reaching probability determination unit 15 determines the determination object link Lm as level 1 (step S34) and returns to step S31. If formula (5) is not met (step S33: NO), the reaching probability determination unit 15 proceeds to step S35.

In step S35, whether or not conditional formula (6) below is met is determined for the determination object link (step S35).

$$Y 0 - {\sum }_{n}^{m - 1} Ync > 0 \qquad formula ( 6 )$$

Formula (6) means that a value of subtraction of the total sum of estimated current necessary remaining amounts Ync from the current position to the determination object link from the current remaining amount Y0 is larger than zero. If formula (6) is met, the vehicle is expected to if the vehicle runs with the estimated current actual fuel efficiency Eac, which is an actual fuel efficiency estimated currently, maintained, be able to continue travelling to the end point of the determination object link Lm without refueling. Also, based on a result of the determination in step S33, formula (7) is met for the determination object link.

$$Y 0 - {\sum }_{n}^{m - 1} Ync > 0 ≧ Y 0 - {\sum }_{n}^{m - 1} Ynb \qquad formula ( 7 )$$

In other words, the determination object link can be regarded as a link in which if the actual fuel efficiency becomes the estimated worst actual fuel efficiency Eab, the vehicle cannot continue travelling to the end point of the link without refueling, but if the actual fuel efficiency continues maintaining the estimated current actual fuel efficiency Eac, the vehicle can continue traveling to the endpoint of the link without refueling. Therefore, if formula (6) is met (step S35: YES), the reaching probability determination unit 15 determines the determination object link Lm as level 2 (step S36), the processing returns to step S31. Contrarily, if formula (6) is not met, formula (8) below is met, and thus, the vehicle is expected to even if the actual fuel efficiency maintains the estimated current actual fuel efficiency Eac, be unable to continue travelling to the end point of the link without refueling.

$$Y 0 - {\sum }_{n}^{m - 1} Ync ≦ 0 \qquad formula ( 8 )$$

If formula (6) is not met (step S35: NO), the reaching probability determination unit 15 proceeds to step S36. In step S36, the reaching probability determination unit 15 determines the determination object link Lm and links subsequent thereto, that is, all of links from the link Lm to the link LM, as level 3 (step S37) and ends the present processing. As described above, the reaching probability is determined for all the links forming the planned running route.

Next, in step S4, based on results of the determination by the reaching probability determination unit 15, the display mode control unit 17 changes a display mode of each link in a route guide image displayed on the display apparatus 2 according to the relevant reaching probability. Then, the HMI control unit 18 changes the display mode of each link displayed on the display apparatus 2, according to the instruction from the display mode control unit 17. For example, the display mode control unit 17 changes a displayed color of each link according to the relevant reaching probability. For example, the display mode control unit 17 displays a link, the reaching probability for which is level 1, in blue, a link, the reaching probability for which is level 2, in yellow, and a link, the reaching probability for which is level 3, in red. Consequently, the user can visually be informed of ranges of the respective reaching probabilities in the planned running route. As a result, the user can visually recognize a range that the vehicle can reach with the current remaining fuel amount and without refueling.

As described above, a link of level 1 is a link in which the vehicle is expected to even if the actual fuel efficiency becomes the estimated worst actual fuel efficiency Eab, be able to continue travelling to an end point of the link without refueling. The user can expect that the vehicle can reach a part displayed in the display mode of level 1 (blue in the present example) in the planned running route, without refueling. Also, a link of level 2 is a link in which the vehicle is expected to if the actual fuel efficiency maintains the estimated current actual fuel efficiency Eac, be able to continue travelling without refueling, but if the actual fuel efficiency becomes the estimated worst actual fuel efficiency Eab, be unable to continue travelling without refueling. The user can expect that for a part displayed in the display mode of level 2 (yellow in the present example) in the planned running route, it may be as well to perform refueling. Furthermore, as described above, a link of level 3 is a link in which the vehicle is expected to even if the actual fuel efficiency maintains the estimated current actual fuel efficiency Eac, be unable to continue travelling without refueling. For a part displayed in the display mode of level 3 (red in the present example) in the planned running route, the user can expect that the vehicle needs to be refueled to reach the part.

As a result of the vehicle-mounted apparatus 1 changing the route display in a graded fashion according to the reaching probabilities in such a manner as above, the user can visually recognize the ranges of the respective reaching probabilities in the planned running route. Consequently, the user can visually recognize a range that the vehicle can reach with the current remaining fuel amount and without refueling, with the reaching probabilities as reference. As a result, the user can determine whether or not refueling is necessary for reaching the destination. Also, the user can see a probability of whether or not the vehicle can reach a particular position partway of the planned running route without refueling. Also, since the vehicle-mounted apparatus 1 causes a planned running route in which reaching probabilities are reflected in display modes to be displayed in a route guide image together with a map image, enabling provision of relevant information for choosing a refueling point (for example, a gas station) to a user. As a result, the user can determine which refueling point on the map to choose for refueling, with the reaching probabilities indicated in the route as references.

The display mode to be changed according to the reaching probabilities is not limited to a type of display color. The display mode to be changed according to the reaching probabilities may be, for example, any of types of mode that enables a user to recognize a difference in reaching probability such as a thickness, a shade or a shape (solid line/dashed line) of a line indicating the route.

FIG. 7 is a diagram illustrating a route guide image displayed on the display apparatus 2 and is a diagram illustrating a specific example for describing the processing in steps S1 to S4. The thick line in FIG. 7 indicates the planned running route from a current position (icon indicated by S in the figure) to the destination (icon indicated by G in the figure). The number of links in the specific example is M=4. In the following, a case where the reaching probability for the link L1 is level 1, the reaching probability for the link L2 is level 2 and reaching probabilities for the link L3 and the link L4 are level 3 will be described. As a result of the route display being changed in a graded fashion according to the reaching probabilities in such a manner as above, the user can visually recognize ranges of the respective reaching probabilities in the planned running route.

In the example illustrated in FIG. 7, in step S1, the information acquisition unit 13 acquires information for determining a reaching probability for each of the links L1 to L4. Next, in step S2, the necessary remaining amount calculation unit 14 calculates an estimated necessary remaining amount based on formulas (1) to (4) for each of the links L1 to L4. Next, in step S3, the reaching probability determination unit 15 determines the reaching probabilities of the links L1 to L4. In step S32, the reaching probability determination unit 15 first selects the link L1 closest to the current position of the relevant vehicle as a determination object link, and in step S33, determines whether or not formula (5) is met for the link L1. The link L1 meets formula (5) and is thus determined as level 1 in step S34. The link L2 does not meet formula (5) in step S33 and thus whether or not the link L2 meets formula (6) is determined in step S35. The link L2 meets formula (6) and thus determined as level 2 in step S36. The link L3 does not meet formula (6) in step S35 and thus determined as level 3 together with the link L4 in step S37. Then, in step S4, the display mode control unit 17 causes the link L1 to be displayed in blue indicating level 1, causes the link L2 to be displayed in yellow indicating level 2 and causes the links L3 and L4 to be displayed in red indicating level 3.

Next, referring back to FIG. 4, steps S5 onwards will be described. In step S5, the information acquisition unit 13 acquires information necessary for determining probabilities of reaching refueling points (gas stations in the present example) (step S5). More specifically, the information acquisition unit 13 selects a plurality of refueling points in the vicinity of the planned running route as suggested candidates based on the map data. Then, the information acquisition unit 13 acquires attribute information, which is information on attributes of the suggested candidates, and use history information, which is information of a history of use of facilities related to the suggested candidates by the user.

The information acquisition unit 13 acquires information of positions of the suggested candidates, information of links from the current position to the suggested candidates, information of types of roads on which the suggested candidates are located (expressway/local road), information of brands of gas stations that are the suggested candidates and information of chains of convenience stores, as an example of facilities attached to the suggested candidates, from the map data or the network as the attribute information of the suggested candidates. Also, the facilities related to the suggested candidates include, e.g., gas stations of brands that are the same as brands of the gas stations that are the suggested candidates and convenience stores often attached to gas stations. The information acquisition unit 13 acquires use history data including the numbers of times of use of gas stations that the user used in the past on a brand-by-brand basis and use history data including the numbers of times of use of convenience stores the user used in the past on a chain-by-chain basis from the storage unit 19 as the use history information of the facilities related to the suggested candidates.

Here, the vehicle-mounted apparatus 1 builds use history data by connecting information on positions of the vehicle at points of time when ACC of the vehicle was turned off and information of facilities on the map data to each other and holds the use history data in the storage unit 19. More specifically, if a facility in the vicinity of a position at which the ACC of the vehicle is turned off is a gas station, the vehicle-mounted apparatus 1 increments the number of times of use of a brand of the gas station and thereby updates the gas station use history data. Likewise, if a facility in the vicinity of a position at which the ACC of the vehicle is turned off is a convenience store, the vehicle-mounted apparatus 1 increments the number of times of use of a chain of the convenience store and thereby updates the convenience store use history data.

Next, in step S6, the necessary remaining amount calculation unit 14 calculates an estimated current necessary remaining amount and an estimated worst necessary remaining amount for each of all links in each of all planned running routes from the current position to the respective suggested candidates. Step S6 is performed by means of processing that is similar to that of step S2.

Next, in step S7, for each of all the suggested candidates, the reaching probability determination unit 15 determines a probability of reaching the suggested candidate from the current position (step S7). Step S7 is performed by means of processing that is similar to that of step S3.

Next, in step S8, the priority provision unit 16 provides priorities to all the suggested candidates based on results of the processing in steps S5 to S7 (step S8). The priorities provided by the priority provision unit 16 to the respective suggested candidates are indexes for determining which suggested candidate is preferentially suggested to the user in displaying icons indicating POIs of the suggested candidates in the route guide image. Although details will be described later, the display mode control unit 17 causes high-priority suggested candidates to be displayed in a more highlighted manner. In other words, priorities are provided to the suggested candidates and the suggested candidates are thereby weighted. The vehicle-mounted apparatus 1 according to the present embodiment provides priority “1” or priority “2” to suggested candidates selected as display objects from among the suggested candidates. Priority “2” indicates a highest priority, and suggested candidates provided with priority “2” are displayed in such a manner that the suggested candidates are highlighted more than suggested candidates provided with priority “1”.

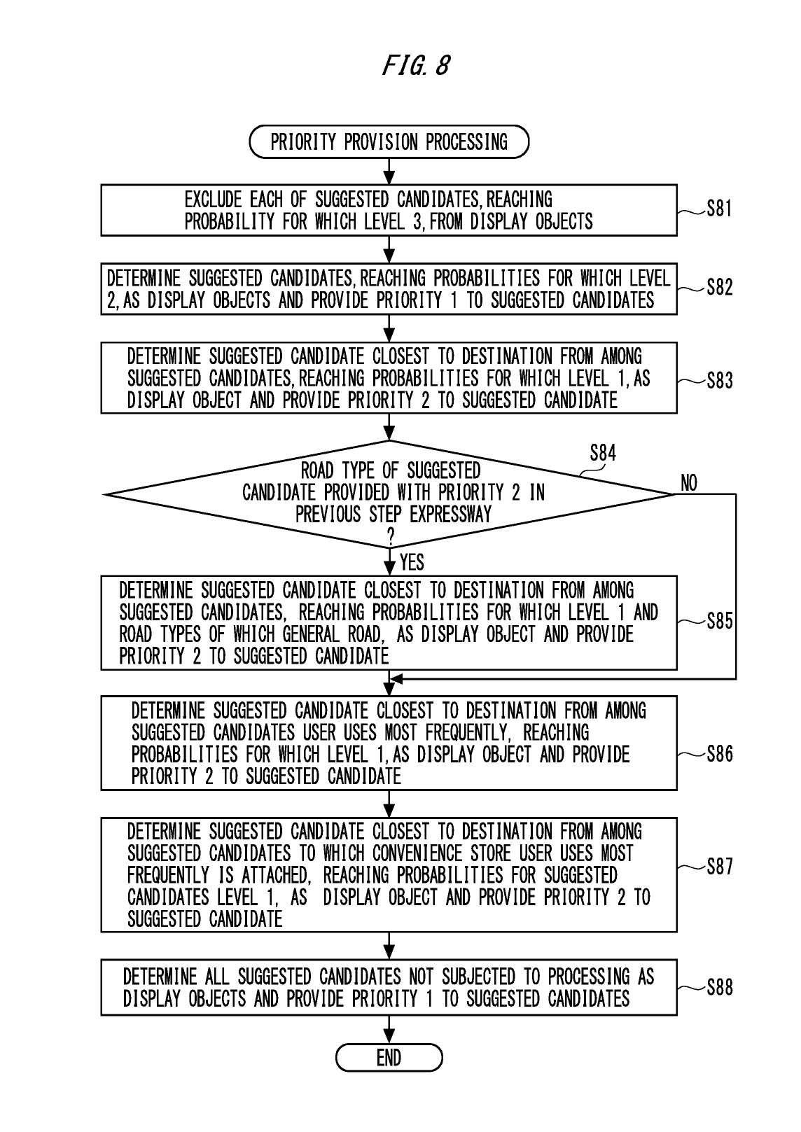

FIG. 8 is a detailed flowchart of the processing performed by the priority provision unit 16 in step S8. First, in step S81, the priority provision unit 16 excludes each of suggested candidates, a probability of reaching the suggested candidate being level 3, from among the plurality of suggested candidates, from display objects (step S81).

Next, in step S82, the priority provision unit 16 determines suggested candidates, the reaching probabilities for which are level 2, as display objects and provides priority “1” to the suggested candidates (step S82).

Next, in step S83, the priority provision unit 16 determines a suggested candidate closest to the destination from among the suggested candidates, the reaching probabilities for which are level 1, as a display object and provides priority “2” to the suggested candidate (step S83).

Next, in step S84, the priority provision unit 16 determines whether or not a road type of the suggested candidate provided with priority “2” in step S83 is an expressway, based on the road type information acquired by the information acquisition unit 13 (step S84). If the road type of the suggested candidate provided with priority “2” in step S83 is an expressway (step S84: YES), in step S85, the priority provision unit 16 determines a suggested candidate closest to the destination from among suggested candidates, reaching probabilities for which are level 1 and road types of which are a local road, as a display object and provides priority “2” to the suggested candidate (step S85). In the following, it is assumed that a condition for providing priority “2” in step S85 is condition 1. Next to step S85, the priority provision unit 16 proceeds to step S86. In step S84, if the road type of the suggested candidate provided with priority “2” in step S83 is a local road (step S84: NO), the priority provision unit 16 does not perform the processing in step S85 and proceeds to step S86.

In step S86, based on the use history data acquired by the information acquisition unit 13, the priority provision unit 16 determines a suggested candidate closest to the destination from among suggested candidates, the reaching probabilities for which are level 1, brands of the suggested candidates agreeing with a brand of a gas station that the user most frequently uses, as a display object and provides priority “2” to the suggested candidate (step S86). Hereinafter, a condition for providing priority “2” in step S86 is referred to as condition 2.

Next, in step S87, based on the use history data acquired by the information acquisition unit 13, the priority provision unit 16 determines a suggested candidate closest to the destination from among suggested candidates to which a convenience store of a chain that is the same as a chain of convenience stores that the user uses most frequently is attached, the reaching probabilities for the suggested candidates being level 1, as a display object and provides priority “2” to the suggested candidate (step S87). Hereinafter, a condition for providing priority “2” in step S86 is referred to as condition 3.

Next, in step S88, the priority provision unit 16 determines all suggested candidates not subjected to the processing in steps S81 to S87 as display objects and provides priority “1” to the suggested candidates (step S88). The processing in step S8 ends in such a manner described above.

Upon the end of the processing in step S8, in step S9, the display mode control unit 17 changes display modes of the suggested candidates determined as display objects in step S8, according to the priorities. More specifically, the display mode control unit 17 changes the display modes so that the suggested candidates provided with priority “2” are highlighted more than the suggested candidates provided with priority “1”. Then, the HMI control unit 18 changes display modes of icons indicating POIs of the respective suggested candidates displayed on the display apparatus 2, according to the instruction from the display mode control unit 17. Consequently, the suggested candidates provided with priority “2” in steps S83, S85, S86 and S87 are displayed so as to be highlighted more than the suggested candidates provided with priority “1” in steps S82 and S88. More specifically, the display mode control unit 17 causes icons of the suggested candidates with priority “2” to be displayed larger than icons of the suggested candidates with priority “1” to highlight the suggested candidates with priority “2”. Here, the display mode control unit 17 displays a brand of refueling points indicated by the icons of the suggested candidates provided with priority “2” in step S86, together with each of the icons, and displays information of facilities attached to the refueling points indicated by the icons of the suggested candidates provided with priority “2” in step S87, together with the icons.

As described above, the display mode control unit 17 causes the suggested candidates to be displayed in such a manner that the suggested candidates provided with priority “2” are highlighted more than the suggested candidates provided with priority “1”. Consequently, high-priority refueling points can be preferentially suggested to the user.

Here, in general, it is preferable that a vehicle be refueled in a state in which a remaining amount is more reduced, that is, at a refueling point closer to a destination because the number of times of refueling can be reduced. The suggested candidate closest to the destination and provided with priority “2” in step S83 is a refueling point that can be reached with an actual fuel efficiency estimated under current conditions and is closest to the destination. Thus, the vehicle-mounted apparatus 1 provides a high priority to such refueling point and displays the refueling point in a highlighted manner, enabling a refueling point of greatly benefit for the user to be suggested preferentially.

Also, in general, a gas station in a service area in an expressway is expensive and may be crowded depending on the season (e.g., a holiday period) and thus many users wish to have their vehicles refueled before entering an expressway. The suggested candidate provided with priority “2” in step S83 or step S85 is a refueling point located at a position closest to the destination, that is, immediately before an expressway, from among the refueling points that can be reached with an actual fuel efficiency estimated under current conditions and are each located along a local road. Thus, the vehicle-mounted apparatus 1 provides a high priority to such refueling point and displays the refueling point in a highlighted manner, enabling preferentially suggesting a refueling point of great benefit for the user.

Furthermore, the suggested candidate provided with priority “2” in step S86 is a refueling point closet to the destination from among refueling points of the brand that the user uses most frequently. In consideration of the user's high-frequency use of the brand, that refueling point is highly likely to be a refueling point that the user uses for preference. Therefore, the vehicle-mounted apparatus 1 displays such refueling point in a highlighted manner, enabling suggesting a refueling point the user desires. For example, gas stations each provide additional values such as obtaining particular points each time the gas station is used and/or making payment easily using, e.g., smart pay, depending on the brand. Such additional values are one of points in a user selecting a gas station. Therefore, providing a high priority to the gas station the user often used in the past and displaying such gas station in a highlighted manner enable suggesting a gas station the user wishes to choose preferentially. Also, the vehicle-mounted apparatus 1 displays information of a brand of a gas station that is a suggested candidate together with an icon of the suggested candidate, enabling provision of relevant information for determining whether or not to choose the gas station to the user.

Also, in general, many users wish to do shopping in a convenience store as well at the time of refueling at a gas station. In reality, there are a great number of gas stations to which a convenience store is attached. The suggested candidate provided with priority “2” in step S87 is a refueling point located at a position closest to the destination from among the refueling points to which the convenience store that the user uses most frequently is attached. In consideration of the user's high frequency use of such attached facility, the user is highly likely to use such attached facility for preference. Thus, providing a high priority to such refueling point and displaying the refueling point in a highlighted manner enable suggesting a refueling point of great benefit for the user preferentially. Also, the vehicle-mounted apparatus 1 displaying information of a convenience store that is a facility attached to a suggested candidate, together with an icon of the suggested candidate, enabling provision of relevant information for determining whether or not to choose the gas station to the user.

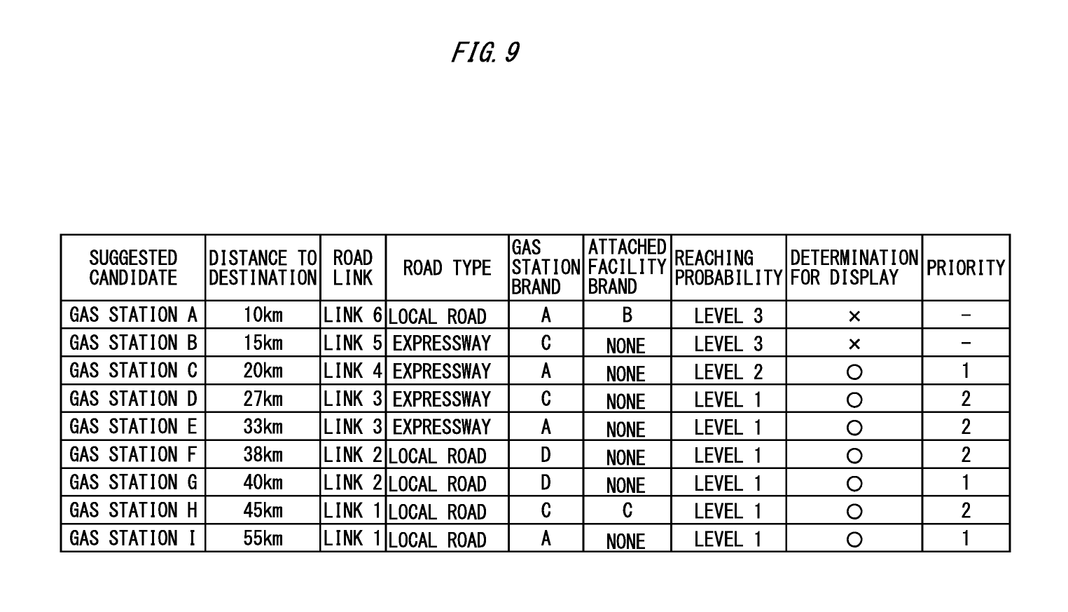

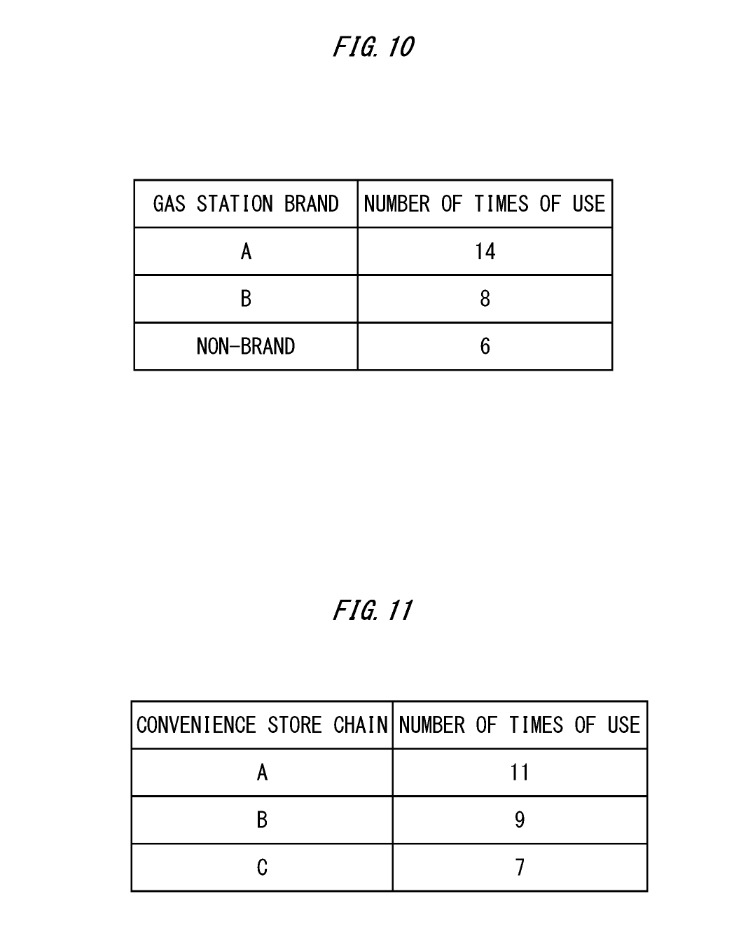

FIG. 9 is a diagram for describing a specific example of the processing in steps S5 to S8. Also, FIG. 10 is a diagram illustrating gas station use history data in the specific example, and FIG. 11 is a diagram illustrating convenience store use history data in the specific example.

Gas stations A to I, which are indicated in FIG. 9, are gas stations located in the vicinity of the planned running route. First, in step S5, the information acquisition unit 13 selects gas stations A to I as suggested candidates and acquires information for determining a reaching probability for each of the suggested candidates. Next, in step S6, the necessary remaining amount calculation unit 14 calculates an estimated current necessary remaining amount and an estimated worst necessary remaining amount for each of all the links in each of all planned running routes from a current position to respective gas stations A to I. Next, in step S7, the reaching probability determination unit 15 determines probabilities of reaching all the respective gas stations A to I from the current position. Then, in step S81, the priority provision unit 16 excludes gas station A and gas station B, the reaching probabilities for which are level 3, from display objects. Next, in step S82, gas station C, the reaching probability for which is level 2, is determined as a display object and provided with priority “1”. Next, in step S83, the priority provision unit 16 determines a gas station D closest to the destination from among the gas stations, the reaching probabilities for which are level 1, as a display object and provides priority “2” to the gas station D. Here, since a road type of gas station D is an expressway, in step S85, the priority provision unit 16 determines gas station F closest to the destination from among gas stations, the reaching probabilities for which are level 1 and road types of which are a local road, as a display object and provides priority “2” to the gas station F. Next, in step S86, the priority provision unit 16 determines gas station E closest to the destination from among gas stations of a brand agreeing with brand A (see FIG. 10) of gas stations that the user uses most frequently, the reaching probability for the gas stations being level 1, as a display object and provides priority “2” to the gas station E. Next, in step S87, the priority provision unit 16 determines gas station H closest to the destination, convenience store C (see FIG. 11) being attached to gas station H, convenience store C being most frequently used by the user from among from among convenience stores attached to gas stations determined as suggested candidates, the reaching probabilities for the gas stations being level 1, as a display object and provides priority “2” to the gas station H. Lastly, in step S88, the priority provision unit 16 determines unprocessed gas stations G, I as display objects and provides priority “1” to gas stations G, I. Provision of priorities to these gas station A to I is performed in such a manner as above.

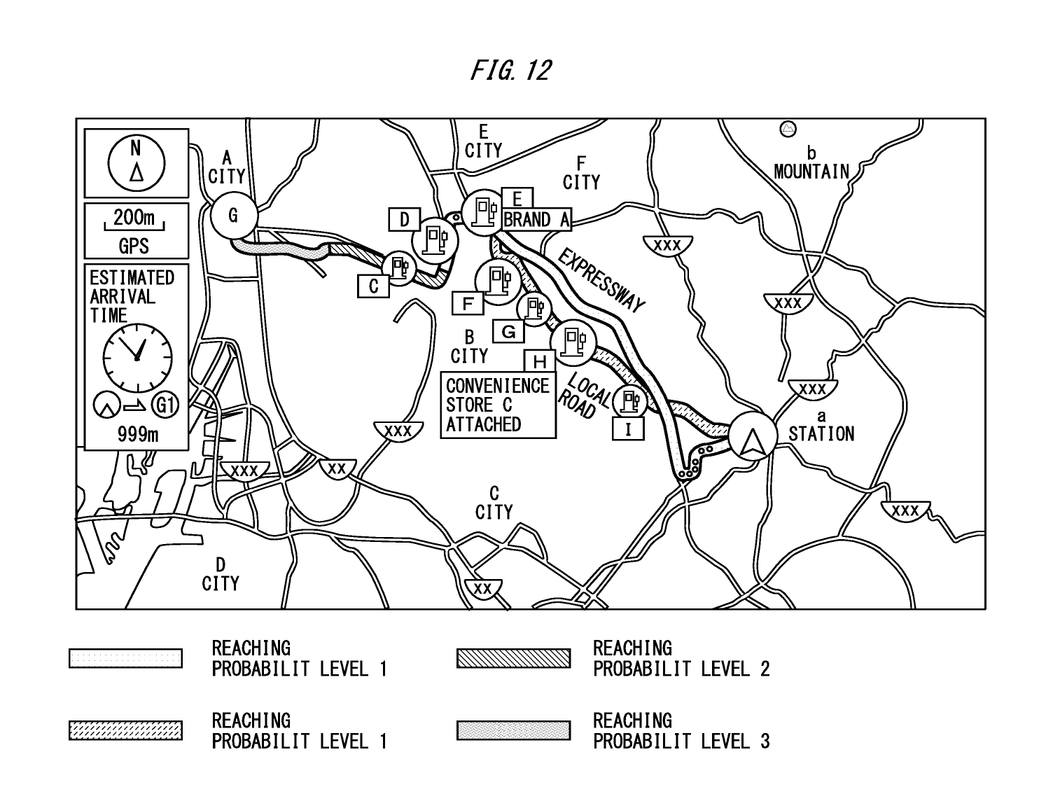

FIG. 12 is a diagram illustrating a route guide image displayed on the display apparatus 2 and is a diagram illustrating a result of the processing in FIG. 9. As illustrated in FIG. 12, gas stations C to I are displayed in a route guide image displayed on a display screen and in particular, icons of gas stations D, E, F, H are displayed in a highlighted manner. Consequently, the user can recognize that gas stations D, E, F, H are recommended refueling points. Also, in the route guide image, a brand of gas station E being brand A frequently used by the user is indicated together with the icon of gas station E, and convenience store C frequently used by the user being attached to gas station H is indicated together with the icon of gas station H.

Here, as described above, the vehicle-mounted apparatus 1 treats condition 1 (refueling point located along a local road), condition 2 (refueling point of a frequently used brand) and condition 3 (refueling point with a facility of a frequently used brand attached thereto) equally and provides priority “2” to conditions 1 to 3. The present invention is not limited to this example and in the above example, suggested candidates meeting any of conditions 1 to 3 may further be prioritized. For example, upon receipt of a selection provided via the user's operation, the priority provision unit 16 may provide a higher priority to a suggested candidate meeting a condition selected by the user from among conditions 1 to 3 (local road/refueling point brand/attached facility brand), relative to the other suggested candidates. Consequently, the suggested candidate meeting a condition particularly preferred by the user can be displayed in a highlighted manner relative to the other suggested candidates.

The display mode changed according to priorities is not limited to a size of a displayed icon. The display mode changed according to priorities may be any display mode that allows the user to recognize a difference in reaching probability according to a difference in mode, for example, a color, a shade or a shape of an icon.

Also, the above-described attached facilities are not limited to convenience store and may be any facilities attached to refueling points.

Referring back to FIG. 4, upon an end of step S9, the processing returns to step S1. The vehicle-mounted apparatus 1 successively performs the processing in steps S2 to S9 during the route guiding by the route guide unit 12. Consequently, the vehicle-mounted apparatus 1 can display a planned running route and suggested candidates in real time based on a remaining fuel amount, a vehicle position, vehicle device statuses and vehicle environment. As a result, the vehicle-mounted apparatus 1 can consistently provide a route guide in an optimum display mode to the user.

Also, as described above, upon a current position of the vehicle deviating from the guide route, the route guide unit 12 updates (reroutes) a guide route from the current position to the destination. Consequently, the processing in steps S1 to S9 is performed for the updated route. As a result, refueling points in the vicinity of the guide route from the current position to the destination can consistently be suggested to the user, enabling the user to reach the destination on an optimum route through a refueling point.

Also, the user can choose a refueling point to stop over from among the suggested candidate refueling points displayed in step 9. The route guide unit 12 searches for an optimum route to the destination through the refueling point selected by the user and reflects the optimum route in the guide route.

Here, if the guide route is rerouted when a particular refueling point is set as a stopover point by the route guide unit 12, the route guide unit 12 cancels the setting of the refueling point as a stopover point. Then, the route guide unit 12 creates a new guide route from the current position to the destination. Then, the display image control processing in steps S1 and S2 is performed based on the rerouted new guide route, and refueling points provided with priorities from among refueling points along the new guide route are suggested to the user. For the user, it is often the case that there is no need to stick to stop over a particular refueling point if refueling is possible. Therefore, when rerouting is performed, the setting of stopping over the refueling point is cancelled and display image control processing is performed based on the rerouted guide route, enabling the user to choose a refueling point as a new stopover point from among refueling points along an optimum route from the current position to the destination. As a result, the user can reach the destination on the optimum route via the refueling point.

The above-described processing in steps S4 to S9 may be started on condition that the probability of reaching the destination is determined as level 3 in step S3.

### Operation and Effects

As described above, the vehicle-mounted apparatus 1 according to the present embodiment includes: the necessary remaining amount calculation unit 14 that for each of links into which a planned running route from a current position of a vehicle to a destination is divided, calculates an estimated necessary remaining amount that is a remaining fuel amount necessary for reaching an end point of the link from the current position of the vehicle; the reaching probability determination unit 15 that based on a current remaining amount and the estimated necessary remaining amount, determines a reaching probability that is a probability of whether or not the vehicle can reach a particular position from the current position without refueling; and the display mode control unit 17 that changes a display mode of a link or an icon that is a display object displayed on a display screen. Also, for each of the links, the reaching probability determination unit 15 determines a probability of reaching an end point of the link. Then, the display mode control unit 17 successively changes display modes of the links displayed in a route guide image according to the reaching probabilities for the respective links determined by the reaching probability determination unit 15.

The above-described vehicle-mounted apparatus 1 according to the present embodiment enables a planned running route to be displayed in a graded fashion according to reaching probabilities. As a result of the route display being changed according to the reaching probabilities in such a manner as described above, the user can visually recognize ranges of the respective reaching probabilities in the planned running route. Consequently, the user can visually recognize a range that the vehicle can reach with a current remaining fuel amount and without refueling, with the reaching probabilities as reference. As a result, the user can determine whether or not refueling is necessary to reach the destination. Also, the user can see a probability of whether or not the vehicle can reach a particular position partway of the planned running route without refueling. Furthermore, the display mode control unit successively changes the display modes according to the reaching probabilities, enabling latest reaching probabilities to be reflected in the display modes. As a result, a correct range that the vehicle can reach with the current remaining fuel amount and without refueling can consistently be displayed. Furthermore, the planned running route in which the reaching probabilities are reflected in the display modes is displayed in a route guide image together with a map image, enabling the user to determine which refueling point on the map to choose for refueling with the reaching probabilities indicated on the route as reference.

Here, a link is an example of “predetermined sections into which a guide route is divided” in the present invention. However, a “predetermined sections into which a guide route is divided” is not limited to a link and may arbitrarily be set.

Also, the vehicle-mounted apparatus includes the information acquisition unit 13 that acquires fuel efficiency influencing factor information that is information on factors influencing fuel efficiency of the vehicle. Then, the necessary remaining amount calculation unit 14 calculates an estimated necessary remaining amount based on the fuel efficiency influencing factor information. Accordingly, a necessary remaining amount can be estimated based on a correct actual fuel efficiency. As a result, correct reaching probabilities can be reflected in the display modes. Also, the information acquisition unit successively acquires information necessary for determining reaching probabilities, enabling correct reaching probabilities to be consistently reflected in the display modes.

Also, the vehicle-mounted apparatus includes the priority provision unit 16 that provides priorities to refueling points in the vicinity of a planned running route. Then, for each of the refueling points, the reaching probability determination unit 15 determines a probability of reaching the refueling point, the priority provision unit 16 provides priorities to the refueling points according to the reaching probabilities for the respective refueling points, and the display mode control unit 17 causes refueling points to be displayed in a route guide image in such a manner that the refueling points are highlighted more in descending order of the priorities. Accordingly, priorities are provided according to the reaching probabilities and the priorities are reflected in display modes. Therefore, the user can visually recognize reachable refueling points. Also, the user can determine which refueling point on a map to choose for refueling with the display modes indicating the priorities according to the reaching probabilities as reference. For example, the user can have the vehicle refueled at a refueling point that can be reached and is closer to the destination.

Furthermore, the priority provision unit 16 provides priorities to refueling points based on information on attributes of the refueling points and information of a history of use of facilities related to the refueling points in addition to the reaching probabilities for the respective refueling points. Accordingly, a refueling point of great benefit for the user can be suggested preferentially.

Here, the functions such as the vehicle position calculation unit 11, the route guide unit 12, the information acquisition unit 13, the necessary remaining amount calculation unit 14, the reaching probability determination unit 15, the priority provision unit 16, the display mode control unit 17, the HMI control unit 18 and the storage unit 19 included in the vehicle-mounted apparatus 1 may be assumed by another component of the navigation system 100 rather than the vehicle-mounted apparatus 1. The navigation system 100 may include vehicle position calculation means, route guide means, information acquisition means, necessary remaining amount calculation means, reaching probability determination means, priority provision means, display mode control means, HMI control means and storage means. For example, the information acquisition means may be provided by various communication apparatuses such as the VICS transmission/reception apparatus 6 and the external communication apparatus 7 in addition to various sensors provided in respective units of the vehicle such as a tire pressure sensor.

Although the present invention has been described above with reference to embodiments, the present invention is not limited to the above embodiments. The above embodiments can be combined as long as such combination is not contradictory.

1. A navigation apparatus to be mounted in a vehicle, the apparatus comprising:
a necessary remaining amount calculation unit that for each of predetermined sections into which a guide route from a current position of the vehicle to a destination is divided, calculates a necessary remaining amount that is a remaining amount of fuel, the remaining amount being necessary for reaching an end point of the section from the current position of the vehicle;
a reaching probability determination unit that based on a current remaining amount of the fuel and the necessary remaining amount, determines a reaching probability that is a probability of whether or not the vehicle can reach a particular position from the current position without refueling; and
a display mode control unit that changes a display mode of a display object displayed in a display image, wherein:
for each of the sections, the reaching probability determination unit determines the reaching probability of reaching an end point of the section; and
the display mode control unit successively changes display modes of the sections displayed in a display image according to the reaching probabilities for the respective sections determined by the reaching probability determination unit.

2. The navigation apparatus according to claim 1, comprising an information acquisition unit that acquires fuel efficiency influencing factor information that is information on a factor influencing fuel efficiency of the vehicle,
wherein the necessary remaining amount calculation unit calculates the necessary remaining amount based on the fuel efficiency influencing factor information.

3. The navigation apparatus according to claim 1, comprising a priority provision unit that provides priorities to refueling points in a vicinity of the guide route, wherein:
for each of the refueling points, the reaching probability determination unit determines the reaching probability of reaching the refueling point;
the priority provision unit provides the priorities to the respective refueling points according to the reaching probabilities for the respective refueling points; and
the display mode control unit displays the refueling points displayed in the display image in such a manner that the refueling points are highlighted more in descending order of the priorities.

4. The navigation apparatus according to claim 3, wherein the priority provision unit provides the priorities to the refueling points according to the reaching probabilities for the respective refueling points and attribute information of the refueling points.

5. The navigation apparatus according to claim 3, wherein the priority provision unit provides the priorities to the refueling points according to the reaching probabilities for the respective refueling points and information of a history of use of facilities related to the refueling points by a user.

6. A navigation system to be mounted in a vehicle, the system comprising:
a necessary remaining amount calculation unit that for each of predetermined sections into which a guide route from a current position of the vehicle to a destination is divided, calculates a necessary remaining amount that is a remaining amount of fuel, the remaining amount being necessary for reaching an end point of the section from the current position of the vehicle;
a reaching probability determination unit that based on a current remaining amount of the fuel and the necessary remaining amount, determines a reaching probability that is a probability of whether or not the vehicle can reach a particular position from the current position without refueling; and
a display mode control unit that changes a display mode of a display object displayed in a display image, wherein:
for each of the sections, the reaching probability determination unit determines the reaching probability of reaching an end point of the section; and
the display mode control unit successively changes display modes of the sections displayed in a display image according to the reaching probabilities for the respective sections.

7. An image display method for a vehicle navigation system, the method comprising:
for each of predetermined sections into which a guide route from a current position of the vehicle to a destination is divided, calculating a necessary remaining amount that is a remaining amount of fuel, the remaining amount being necessary for reaching an end point of the section from the current position of the vehicle;
based on a current remaining amount of the fuel and the necessary remaining amount, determining a reaching probability that is a probability of whether or not the vehicle can reach a particular position from the current position without refueling; and
changing a display mode of a display object displayed in a display image, wherein:
for each of the sections, the determining determines the reaching probability of reaching an end point of the section; and
the changing successively changes display modes of the sections displayed in a display image according to the reaching probabilities for the respective sections.
